(19) United States
(12) Patent Application Publication
(10) Pub. No.: US 2017/0235781 A1
(43) Pub. Date: Aug. 17, 2017

(54) METHOD, SERVER AND COMPUTER PROGRAM STORED IN COMPUTER READABLE MEDIUM FOR MANAGING LOG DATA IN DATABASE

(71) Applicant: TmaxData Co., Ltd., Gyeonggi-do (KR)

(72) Inventors: Ingyu KANG, Jeollabuk-do (KR); Sangyoung PARK, Jeollabuk-do (KR); JaeSeok AN, Gyeonggi-do (KR)

(21) Appl. No.: 15/089,450

(22) Filed: Apr. 1, 2016

(30) Foreign Application Priority Data
Feb. 16, 2016 (KR) 10-2016-0017982

(51) Int. Cl. G06F 17/30

(52) U.S. Cl. CPC G06F 17/30368; G06F 17/30386

(57) ABSTRACT

Disclosed are a method, a server, and a computer program for managing log data in a database. The method for managing log data in a database includes: receiving a request for an update for a specific row including one or more columns designated to be updated, the specific row being positioned within a table of a database; comparing a column value before the update with a column value after the update in a unit of the column for the one or more columns designated to be updated; determining a column, in which the column value before the update is matched with the column value after the update, among the columns designated to be updated in the specific row, based on the comparison; and determining not to generate log data for the determined column, the log data being related to the request for the update.

### CROSS-REFERENCE TO RELATED APPLICATIONS

This application claims priority to and the benefit of Korean Patent Application No. 10-2016-0017982 filed in the Korean Intellectual Property Office on Feb. 16, 2016, the entire contents of which are incorporated herein by reference.

### TECHNICAL FIELD

The present disclosure relates to a method for managing log data in a database, and more particularly, to a method for adaptively generating log data.

### BACKGROUND ART

A technology for a large database managing system, such as a large structured or unstructured data set, and big data processing of extracting a value from the data and analyzing a result, beyond a capability of collecting, storing, managing, and analyzing data with an existing database management tool, has been developed.

The database managing system storing large data requires a method for guaranteeing integrity, confidentiality, and availability of data.

To this end, the database managing system requires log data. The log data of the database may store transaction or operation information generated and performed during a change or an operation of the database, and may be used for restoring the database when the database has an error. The log data may be first stored before corresponding contents are reflected to the database according to a write ahead log (WAL) method.

Currently, the database is managed on a large scale, and the quantity of transaction performed while accessing the database is also geometrically increased. Accordingly, the quantity of log data is also geometrically increased.

When the quantity of log data is increased, the large quantity of I/O of a disk is generated, thereby negatively influencing general performance of the database. Accordingly, research on a technology for decreasing the quantity of log data is required.

### RELATED ART LITERATURE

### Patent Document

Korean Patent Application Laid-Open No. 10-2006-0058546

U.S. Pat. No. 7,111,005

### SUMMARY OF THE INVENTION

The present disclosure has been made in an effort to decrease the quantity of log data recorded in a persistent storage medium by adaptively generating log data within a database system.

The exemplary embodiments of the present disclosure for carrying out the aforementioned objects are suggested.

An exemplary embodiment of the present disclosure provides a method for managing log data in a database, the method including: receiving a request for an update for a specific row including one or more columns designated to be updated, the specific row being positioned within a table of a database; comparing a column value before the update with a column value after the update in a unit of the column for the one or more columns designated to be updated; determining a column, in which the column value before the update is matched with the column value after the update, among the columns designated to be updated in the specific row, based on the comparison; and determining not to generate log data for the determined column, the log data being related to the request for the update.

Another exemplary embodiment of the present disclosure provides a method for managing log data in a database, the method including: receiving a request for an update for a specific row including one or more columns designated to be updated, the specific row being positioned within a table of a database; comparing a column value before the update with a column value after the update in a unit of the column for the one or more columns designated to be updated; determining a column, in which the column value before the update is matched with the column value after the update, among the columns designated to be updated in the specific row, based on the comparison; and determining not to store a part of the log data related to the update corresponding to the determined column in a log data buffer, the log data being related to the request for the update.

Another exemplary embodiment of the present disclosure provides a method for managing log data in a database, the method including: receiving a request for an update for a specific row including one or more columns designated to be updated, the specific row being positioned within a table of a database; comparing a column value before the update with a column value after the update in a unit of the column for the one or more columns designated to be updated; determining a column, in which the column value before the update is matched with the column value after the update, among the columns designated to be updated in the specific row, based on the comparison; and determining not to record a part of the log data related to the update corresponding to the determined column in a persistent storage medium, the log data being related to the request for the update.

Another exemplary embodiment of the present disclosure provides a database managing program, which is stored in a computer readable medium and includes commands commanding a computer to perform operations, the operations including: an operation of receiving a request for an update for a specific row including one or more columns designated to be updated, the specific row being positioned within a table of a database; an operation of comparing a column value before the update with a column value after the update in a unit of the column for the one or more columns designated to be updated; an operation of determining a column, in which the column value before the update is matched with the column value after the update, among the columns designated to be updated in the specific row, based on the comparison; and an operation of determining not to generate log data for the determined column, the log data being related to the request for the update.

Another exemplary embodiment of the present disclosure provides a database managing program, which is stored in a computer readable medium and includes commands commanding a computer to perform operations, the operations including: an operation of receiving a request for an update for a specific row including one or more columns designated to be updated, the specific row being positioned within a table of a database; an operation of comparing a column value before the update with a column value after the update in a unit of the column for the one or more columns designated to be updated; an operation of determining a column, in which the column value before the update is matched with the column value after the update, among the columns designated to be updated in the specific row, based on the comparison; and an operation of determining not to store a part of the log data related to the update corresponding to the determined column in a log data buffer, the log data being related to the request for the update.

Another exemplary embodiment of the present disclosure provides a database managing program, which is stored in a computer readable medium and includes commands commanding a computer to perform operations, the operations including: an operation of receiving a request for an update for a specific row including one or more columns designated to be updated, the specific row being positioned within a table of a database; an operation of comparing a column value before the update with a column value after the update in a unit of the column for the one or more columns designated to be updated; an operation of determining a column, in which the column value before the update is matched with the column value after the update, among the columns designated to be updated in the specific row, based on the comparison; and an operation of determining not to record a part of the log data related to the update corresponding to the determined column in a persistent storage medium, the log data being related to the request for the update.

Another exemplary embodiment of the present disclosure provides a database server, including: a transceiving module configured to receive a request for an update for a specific row including one or more columns designated to be updated, the specific row being positioned within a table of a database; a column value comparing module configured to compare a column value before the update with a column value after the update in a unit of the column for the one or more columns designated to be updated; a column determining module configured to determine a column, in which the column value before the update is matched with the column value after the update, among the columns designated to be updated in the specific row, based on the comparison; and a log data generating module configured to determine not to generate log data for the determined column, the log data being related to the request for the update.

According to the present disclosure, it is possible to decrease the quantity of log data recorded in a persistent storage medium by adaptively generating log data within a database system.

### BRIEF DESCRIPTION OF THE DRAWINGS

Various aspects are described with reference to the drawings, and herein, like reference numerals are generally used to designate like constituent elements. In the exemplary embodiment below, for the purpose of description, a plurality of specific and detailed matters are suggested in order to provide general understanding one or more aspects. However, it is apparent that the aspect(s) may be carried out without the specific and detailed matters. In other examples, publicly-known structures and devices are illustrated in a form of a block diagram for easy description.

FIG. 1 is a diagram illustrating an example of a database system 1200 according to an exemplary embodiment of the present disclosure.

FIG. 2 is a diagram illustrating an example of components of a database server according to an exemplary embodiment of the present disclosure.

FIG. 3 is a diagram for describing a method for adaptively generating log data related to a request for an update by the database server according to the exemplary embodiment of the present disclosure.

FIG. 4 is a diagram for describing a method for adaptively storing log data related to a request for an update in a log data buffer by the database server according to the exemplary embodiment of the present disclosure.

FIG. 5 is a diagram for describing a method for adaptively storing log data related to a request for an update in a persistent storage medium by the database server according to the exemplary embodiment of the present disclosure.

FIGS. 6A and 6B are diagrams for describing a method for adaptively generating, storing, and recording log data related to a request for an update by the database server according to the exemplary embodiment of the present disclosure.

### DETAILED DESCRIPTION

Various exemplary embodiments will be described with reference to the accompanying drawings, and like reference numerals are used for designating like constituent elements throughout the specification. In the present specification, various descriptions are suggested for helping to understand the present disclosure. However, it is apparent that the exemplary embodiments may be carried out without a particular description. In other examples, publicly-known structures and devices are provided in a form of a block diagram in order to easily describe the exemplary embodiments.

Terms “component”, “module”, “system”, and the like used in the present specification refer to a computer-related entity, hardware, firmware, software, a combination of software and hardware, or execution of software. For example, the component may be a processing process, a processor, an object, an execution thread, a program, and/or a computer executed in a processor, but is not limited thereto. For example, all of an application executed in a computing device and the computing device may be components. One or more components may reside within a processor and/or an execution thread, and one component may be localized within one computer, or distributed between two or more computers. Further, the components may be executed by various computer readable media having various data structures stored in the media. The components may communicate through local and/or remote processing according to, for example, a signal (for example, data transceived with another system through a network, such as the Internet, from one component inter-working with another component in a local system and a distribution system) including one or more data packets.

In the present specification, a database means a system storing related data in a computer processible form. The database may store data and answer a question of a user, and the data stored in the database may be changed. The database may store new data, and perform an operation of deleting and changing existing data.

In the present specification, a transaction means a continuous processing unit for a series of operations, such as information exchange or database update. The transaction may be defined as a basic unit of an operation for completing a requested operation in a state where an integrity of database guaranteed.

In the present specification, log data means data recording contents related to a data change, such as a generation of a transaction or operation information, during an operation of a database. The log data may contain redo log data and undo log data.

The redo log data means data required for restoring a database when the database has a fail.

The type of restoration performed by using the redo log data includes a media recovery used for restoring a database when a media fail, which is generated when a disk is physically damaged, is generated, and an instance recovery for preparing for a loss of transaction data when an instance is abnormally terminated, but is not limited thereto.

The undo log data means data required for returning an operation performed in the database. For example, when a database managing system cancels a transaction applied to the database, undo log data may be required.

Descriptions of the suggested exemplary embodiments are provided so that those skilled in the art may use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics suggested herein.

Hereinafter, exemplary embodiments according to the present disclosure will be described with reference to the accompanying drawings in detail.

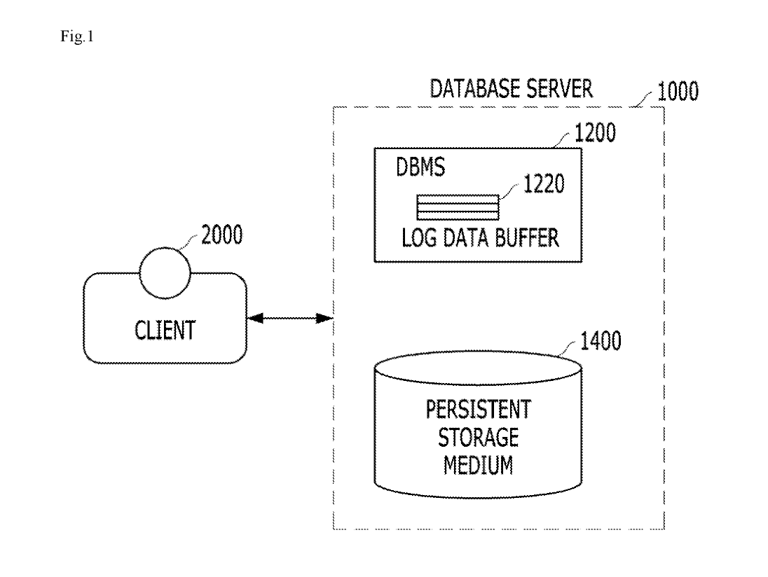

FIG. 1 is a diagram illustrating an example of a database system 1200 according to an exemplary embodiment of the present disclosure.

A database server 1000 may include a predetermined type of computer system or computer device, such as a micro-processor, a main frame computer, a digital single processor, a portable device, and a device controller.

A client 2000 may mean nodes in the database system having a mechanism for communication through a network. For example, the client 2000 may include a PC, a laptop computer, a workstation, a terminal, and/or a predetermined electronic device having network accessibility. Further, the client 2000 may include a predetermined server implemented by at least one of an agent, an application programming interface (API), and a plug-in.

The database server 1000 may include a database management system (DBMS) 1200 and a persistent storage medium 1400.

The database managing system may include a log data buffer 1220. The log data buffer 1220 may store log data. For example, the log data buffer 1220 may store log data generated by a log data managing module 1260. The log data buffer 1220 may be implemented by one or more memories.

Here, the memory is a main storage device, such as a random access memory (RAM) including a dynamic random access memory (DRAM) and a static random access memory (SRAM), which a processor directly accesses, and may mean a volatile storage device, in which when a power supply is turned off, stored information is momentarily erased, but is not limited thereto. The memory may be operated by a processor.

The persistent storage medium 1400 means a non-volatile storage medium, such as a storage device based on a flash memory and/or a battery-backup memory, which is capable of continuously storing predetermined data, as well as a magnetic disk, an optical disk, and a magneto-optical storage device. The persistent storage medium 1400 may communicate with a processor and a memory of the database server 1000 through various communication means. In an additional exemplary embodiment, the persistent storage medium 1400 may be positioned outside the database server 1000 and also communicate with the database server 1000.

The client 200 and the database server 1000 may communicate with each other through a network. A network according to the exemplary embodiment of the present disclosure may use various wired communication systems, such as a public switched telephone network (PSTN), an x digital subscriber line (xDSL), a rate adaptive DSL (RADSL), a multi rate DSL (MDSL), a very high speed DSL (VDSL), a universal asymmetric DSL (UADSL), a high bit rate DSL (HDSL), and a local area network (LAN).

The network suggested in the present specification may use various wireless communication systems, such as code division multiple access (CDMA), time division multiple access (TDMA), frequency division multiple access (FDMA), orthogonal frequency division multiple access (OFDMA), single carrier-FDMA (SC-FDMA), and other systems. The technologies described in the present specification may be used in other networks, as well as the aforementioned networks.

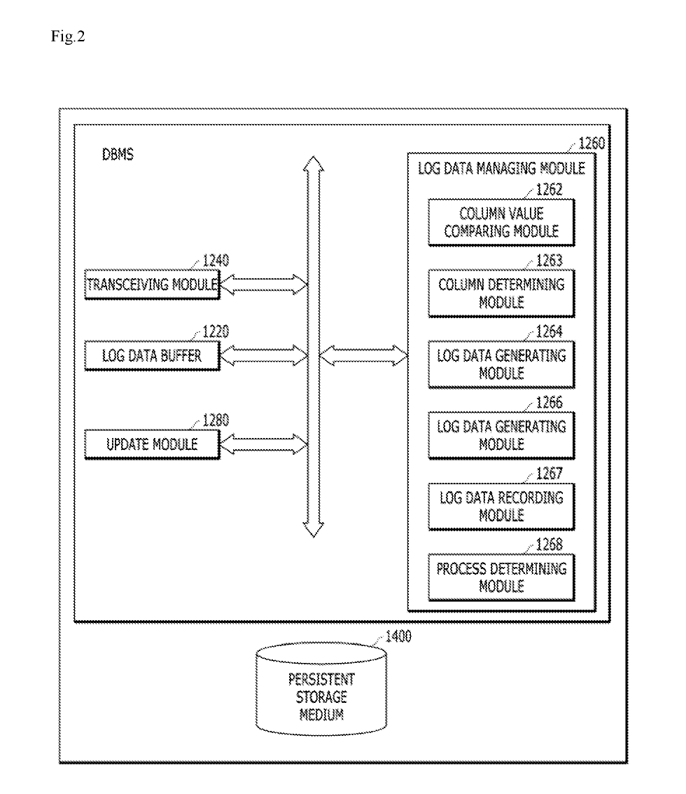

FIG. 2 is a diagram illustrating an example of components of the database server according to an exemplary embodiment of the present disclosure.

As illustrated in FIG. 2, the database server 1000 may include the persistent storage medium 1400 and the database managing system 1200. The database managing system may be implemented by one or more memories and one or more processors within the database server 1000.

The database managing system 1200 may include a transceiving module 1240, the log data buffer 1220, a log data managing module 1260, and an update module 1280. Further, the log data managing module 1260 may include a column value comparing module 1262, a column determining module 1263, a log data generating module 1264, a log data storing module 1266, and a log data recording module 1267.

The transceiving module 1240 may receive a request for data storage and inquiry, index build and inquiry, and the like from a user. Further, the transceiving module 1240 may receive a request for updating data included in the database from the user.

The data included in the database may have a form of a table, and the request for the update may designate one or more columns designated to be updated included in a specific row of the table. In this case, the request for the update may include a request for changing a column value of one or more columns among the one or more columns designated to be updated.

For example, the request for the update may include a data manipulation language (DML) request for changing a column value of one or more columns among the one or more columns designated to be updated.

The specific row may include one row or a plurality of rows.

The log data managing module 1260 may generate log data related to the request for the update. In this case, the log data managing module 1260 may adaptively generate log data. Further, the log data managing module 1260 may adaptively store log data in the memory (for example, the log data buffer). Further, the log data managing module 1260 may adaptively record log data in the persistent storage medium (for example, a disk).

In this case, the log data managing module 1260 may perform an operation of generating log data before performing the update according to the request for updating the data. Further, the log data managing module 1260 may perform an operation of generating log data before performing the update according to the request for updating the data, and perform an operation of recording log data before performing the update according to the request for updating the data, but is not limited thereto.

According to the exemplary embodiment of the present disclosure, the log data managing module 1260 may adaptively generate log data related to the request for the update.

In response to receiving, by the database server 1000, the request for the update for the specific row including the one or more columns designated to be updated, the column value comparing module 1262 may compare a column value before the update with a column value after the update in a unit of the column for the one or more columns designated to be updated.

For example, when the database server 1000 receives the request for updating a first column, a second column, a third column, a fourth column, and a fifth column, which are included in the specific row, the column value comparing module 1262 may compare a column value before the update with a column value after the update for each of the first column, the second column, the third column, the fourth column, and the fifth column.

The column determining module 1263 may determine one or more columns, in which the column value before the update is matched with the column value after the update, among the columns designated to be updated in the specific row based on a result of the comparison by the column value comparing module 1262.

The column determining module 1263 may determine one or more columns, in which the column value before the update is not matched with the column value after the update, among the columns designated to be updated in the specific row based on a result of the comparison by the column value comparing module 1262.

The log data generating module 1264 may determine not to generate log data for the one or more columns, in which the column value before the update is matched with the column value after the update, among the columns designated to be updated.

The log data generating module 1264 may determine to generate log data for the one or more columns, in which the column value before the update is not matched with the column value after the update, among the columns designated to be updated.

The log data generating module 1264 may generate the log data for the columns, in which the column values are actually changed, instead of generating the log data for all of the columns requested to be updated, thereby decreasing the quantity of log data.

According to another exemplary embodiment of the present disclosure, the log data managing module 1260 may adaptively store log data related to the request for the update in the memory (for example, the log data buffer).

In response to receiving, by the database server 1000, the request for the update for the specific row including the one or more columns designated to be updated, the log data generating module 1264 may generate log data. The log data generating module 1264 may generate log data for the specific row, and generate log data for the one or more columns designated to be updated, and is not limited thereto.

The column value comparing module 1262 may compare a column value before the update with a column value after the update in a unit of the column for the one or more columns designated to be updated.

For example, when the database server 1000 receives the request for updating a first column, a second column, a third column, a fourth column, and a fifth column, which are included in the specific row, the column value comparing module 1262 may compare a column value before the update with a column value after the update for each of the first column, the second column, the third column, the fourth column, and the fifth column.

The column determining module 1263 may determine one or more columns, in which the column value before the update is matched with the column value after the update, among the columns designated to be updated in the specific row, based on a result of the comparison by the column value comparing module 1262.

The column determining module 1263 may determine one or more columns, in which the column value before the update is not matched with the column value after the update, among the columns designated to be updated in the specific row, based on a result of the comparison by the column value comparing module 1262.

The log data storing module 1266 may determine not to store log data for the one or more columns, in which the column value before the update is matched with the column value after the update, among the columns designated to be updated.

For example, the log data storing module 1266 may determine not to store a part of the generated log data for the one or more columns, in which the column value before the update is matched with the column value after the update, among the columns designated to be updated. In this case, the log data storing module 1266 may store the log data except for the part, which is determined not to be stored, in the log data buffer 1220.

The log data storing module 1266 may determine to store the log data among the generated log data for the one or more columns, in which the column value before the update is not matched with the column value after the update, among the columns designated to be updated. In this case, the log data storing module 1266 may store a part of the log data determined to be stored in the log data buffer 1220.

The log data storing module 1266 may store the log data for the columns, in which the column values are actually changed, instead of storing the log data for all of the columns requested to be updated, in the log data buffer 1220, thereby decreasing the quantity of log data.

According to another exemplary embodiment of the present disclosure, the log data managing module 1260 may adaptively record the log data related to the request for the update in the persistent storage medium.

In response to receiving, by the database server 1000, the request for the update for the specific row including the one or more columns designated to be updated, the log data generating module 1264 may generate log data. The log data generating module 1264 may generate log data for the specific row, and generate log data for the one or more columns designated to be updated, and is not limited thereto.

The log data storing module 1266 may store the generated log data in the log data buffer 1220.

The column value comparing module 1262 may compare a column value before the update with a column value after the update in a unit of the column for the one or more columns designated to be updated.

For example, when the database server 1000 receives the request for updating a first column, a second column, a third column, a fourth column, and a fifth column, which are included in the specific row, the column value comparing module 1262 may compare a column value before the update with a column value after the update for each of the first column, the second column, the third column, the fourth column, and the fifth column.

The column determining module 1263 may determine one or more columns, in which the column value before the update is matched with the column value after the update, among the columns designated to be updated in the specific row, based on a result of the comparison by the column value comparing module 1262.

The column determining module 1263 may determine one or more columns, in which the column value before the update is not matched with the column value after the update, among the columns designated to be updated in the specific row, based on a result of the comparison by the column value comparing module 1262.

The log data recording module 1267 may determine not to record log data for the one or more columns, in which the column value before the update is matched with the column value after the update, among the columns designated to be updated.

For example, the log data recording module 1267 may determine not to record a part for the one or more columns, in which the column value before the update is matched with the column value after the update, among the columns designated to be updated, in the persistent storage medium 1400. In this case, the log data recording module 1267 may record the log data except for the part, which is determined not to be recorded, in the persistent storage medium 1400.

The log data recording module 1267 may determine to record the log data among the generated log data for the one or more columns, in which the column value before the update is not matched with the column value after the update, among the columns designated to be updated, in the persistent storage medium 1400. In this case, the log data recording module 1267 may record a part of the stored log data, which is determined to be recorded, in the persistent storage medium 1400.

In this case, the operation of recording the log data in the persistent storage medium 1400 may be performed by the log data recording module 1267, and by a background process. The background process may include a data buffer writer process, a data block writer process, a checkpoint process, and a log writer process, and is not limited thereto.

In this case, the log data recording module 1267 may store the log data in the persistent storage medium in a form of a redo log file. The redo log file means a file, in which the log data, which is various information to be stored in preparation of fail generated within the operated database managing system 1200 is formally recorded. For example, the redo log file may include data necessary for recovering specific data into a state just before the fail is generated. For example, the redo log file may include particular contents, such as data changed according to the generation of a transaction, a transaction generation time, a processing time, a data change, and processing details.

The log data recording module 1267 may record the log data for the columns, in which the column values are actually changed, instead of recording the log data for all of the columns requested to be updated, in the persistent storage medium 1400, thereby decreasing the quantity of recorded log data.

The aforementioned exemplary embodiments are individually described for convenience of the description, but according to another exemplary embodiment of the present disclosure, the database server 1000 may combine a part or the entirety of the aforementioned exemplary embodiments and provide the combined exemplary embodiment.

For example, the log data managing module 1260 may perform two or more of the operation of adaptively generating the log data, the operation of adaptively storing the log data, and the operation of adaptively recording the log data together, and is not limited thereto.

According to the exemplary embodiment of the present disclosure, the update module 1280 may update data according to a request for an update. For example, the update module 1280 may copy a table requested to be updated from the persistent storage medium 1400 and store the copied table in the memory. The update module 1280 may update the table stored in the memory according to a request for an update.

The updated data (for example, the updated table) may be recorded in the persistent storage medium 1400. The operation of recording the updated data in the persistent storage medium 1400 may be performed by the update module 1280, and may be implemented by a background process (for example, a data buffer writer process, a data block writer process, a checkpoint process, and/or a log writer process), and is not limited thereto.

The database managing system 1200 may notify that the performance of the update is completed after performing the update. For example, the database managing system 1200 may notify the client 200 requesting the update that the performance of the update is completed after performing the update.

In this case, the database managing system 1200 may notify information about an update result of the one or more columns designated to be updated together. For example, the database managing system 1200 may notify at least one of information (for example, identification information about the columns) about the one or more columns, in which the column value before the update is matched with the column value after the update, among the columns designated to be updated, and information (for example, identification information about the columns) about the one or more columns, in which the column value before the update is not matched with the column value after the update, among the columns designated to be updated, together with the information about the update result.

According to the exemplary embodiment of the present disclosure, the log data managing module 1260 may determine whether to adaptively generate log data based on a predetermined condition.

For example, when a remaining storage capacity of the log data buffer 1220 and/or a remaining recording capacity of the persistent storage medium 1400 are/is equal to or smaller than a threshold value, the log data managing module 1260 may determine to adaptively generate log data.

When the quantity of log data stored in the log data buffer 1220 and/or the quantity of log data recorded in the persistent storage medium 1400 are/is equal to or larger than the threshold value, the log data managing module 1260 may determine to adaptively generate log data.

For another example, when a remaining storage capacity of the log data buffer 1220 and/or a remaining recording capacity of the persistent storage medium 1400 is equal to or smaller than a threshold value, the log data managing module 1260 may determine to adaptively store the log data in the log data buffer 1220.

When the quantity of log data stored in the log data buffer 1220 and/or the quantity of log data recorded in the persistent storage medium 1400 are/is equal to or larger than the threshold value, the log data managing module 1260 may determine to adaptively store the log data in the log data buffer 1220.

For another example, when a remaining storage capacity of the log data buffer 1220 and/or a remaining recording capacity of the persistent storage medium 1400 are/is equal to or smaller than a threshold value, the log data managing module 1260 may determine to adaptively record the log data in the persistent storage medium 1400.

When the quantity of log data stored in the log data buffer 1220 and/or the quantity of log data recorded in the persistent storage medium 1400 are/is equal to or larger than the threshold value, the log data managing module 1260 may determine to adaptively record the log data in the persistent storage medium 1400.

The aforementioned predetermined condition is simply an exemplary embodiment. For example, the log data managing module 1260 may determine to adaptively generate log data according to a ratio of a remaining storage capacity to the entire storage capacity of the log data buffer 1220, and determine to adaptively generate log data according to a ratio of a remaining storage capacity to the entire storage capacity of the persistent storage medium 1400, and the log data managing module 1260 may determine whether to adaptively generate log data based on various references without limiting thereto.

The log data managing module 1260 may determine whether to adaptively store log data in the log data buffer 1220 based on the aforementioned various references, and determine whether to adaptively record the log data in the persistent storage medium 1400.

According to another embodiment of the present disclosure, the log data managing module 1260 may adaptively generate log data related to the plurality of rows.

The database managing system 1200 may receive a request for updating the plurality of rows. For example, the request for the update may designate one or more columns included in the plurality of rows. In this case, the request for the update may include a request for changing a column value of one or more columns among the one or more columns designated to be updated.

The log data managing module 1260 may generate log data for the plurality of rows in response to the request for the update. In this case, the log data managing module 1260 may select a row, for which log data is to be adaptively generated, among the plurality of rows. The log data managing module 1260 may adaptively generate log data for the selected rows, adaptively store the log data for the selected rows in the log data buffer 1220, and adaptively record the log data for the selected rows in the persistent storage medium 1400.

For example, the log data managing module 1260 may generate log data for the plurality of rows (for example, a first row, a second row, and a third row), select a row (for example, the first row and the second row), for which log data is to be adaptively generated, among the plurality of rows, and adaptively generate log data for the selected rows (for example, the first row and the second row).

In this case, the log data managing module 1260 may select a row, for which log data is to be adaptively generated, according to a predetermined condition.

For example, the log data managing module 1260 may select rows, in which the number of columns, in which the column value before the update is matched with the column value after the update is equal to or smaller than a threshold value, among the columns designated to be updated as rows, for which the log data is to be adaptively generated.

The aforementioned predetermined condition is simply an exemplary embodiment, and the predetermined condition is not limited thereto, and may include various conditions.

According to another exemplary embodiment of the present disclosure, the log data managing module 1260 may further include a process determining module 1268 determining the operations of the log data generating module 1264, the log data storing module 1266, and the log data recording module 1267.

The process determining module 1268 may determine the operations of the log data generating module 1264, the log data storing module 1266, and the log data recording module 1267.

For example, the process determining module 1268 may determine whether to adaptively generate log data, adaptively store the log data in the log data buffer 1262, and adaptively record the log data in the persistent storage medium 1400.

For another example, the process determining module 1268 may determine not to generate log data for the one or more columns, in which the column value before the update is matched with the column value after the update, among the columns designated to be updated.

The process determining module 1268 may determine to generate log data for the one or more columns, in which the column value before the update is not matched with the column value after the update, among the columns designated to be updated.

The process determining module 1268 may transmit a command based on the determination result to the log data generating module 1264. The log data generating module 1264 may adaptively generate log data according to the command of the process determining module 1268.

The process determining module 1268 may transmit the command based on the determination result to the log data storing module 1266. The log data storing module 1266 may adaptively store the log data in the log data buffer 1220 according to the command of the process determining module 1268.

The process determining module 1268 may transmit the command based on the determination result to the log data recording module 1267. The log data recording module 1267 may adaptively record the log data in the persistent storage medium 1400 according to the command of the process determining module 1268.

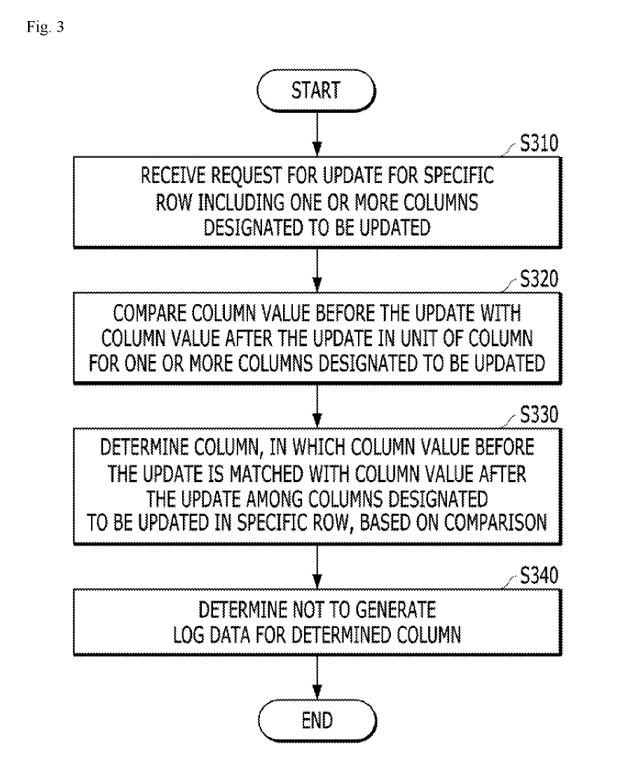

FIG. 3 is a diagram for describing a method for adaptively generating log data related to a request for an update by the database server according to the exemplary embodiment of the present disclosure.

In operation S310, the database server 1000 may receive a request for data storage and inquiry, index build and inquiry, and the like from a user. Further, the database server 1000 may receive a request for updating data included in the database from the user.

The data included in the database may have a form of a table, and the request for the update may designate one or more columns included in a specific row of the table to be updated. In this case, the request for the update may include a request for changing a column value of one or more columns among the one or more columns designated to be updated.

For example, the request for the update may include a DML request for changing a column value of one or more columns among the one or more columns designated to be updated.

In this case, the specific row may include one row or a plurality of rows, and is not limited thereto.

In response to receiving, by the database server 1000, the request for the update for the specific row including the one or more columns designated to be updated, in operation S320, the database server 1000 may compare a column value before the update with a column value after the update in a unit of the column for the one or more columns designated to be updated.

For example, when the database server 1000 receives the request for updating a first column, a second column, a third column, a fourth column, and a fifth column, which are included in the specific row, the column value comparing module 1262 may compare a column value before the update with a column value after the update for each of the first column, the second column, the third column, the fourth column, and the fifth column.

In operation S330, the database server 1000 may determine one or more columns, in which the column value before the update is matched with the column value after the update, among the columns designated to be updated in the specific row, based on a result of the comparison.

The database server 1000 may determine one or more columns, in which the column value before the update is not matched with the column value after the update, among the columns designated to be updated in the specific row, based on the result of the comparison.

In operation S340, the database server 1000 may determine not to generate log data for the one or more columns, in which the column value before the update is matched with the column value after the update, among the columns designated to be updated.

The database server 1000 may determine to generate log data for the one or more columns, in which the column value before the update is not matched with the column value after the update, among the columns designated to be updated.

The database server 1000 may generate the log data for the columns, in which the column values are actually changed, instead of generating the log data for all of the columns requested to be updated, thereby decreasing the quantity of log data.

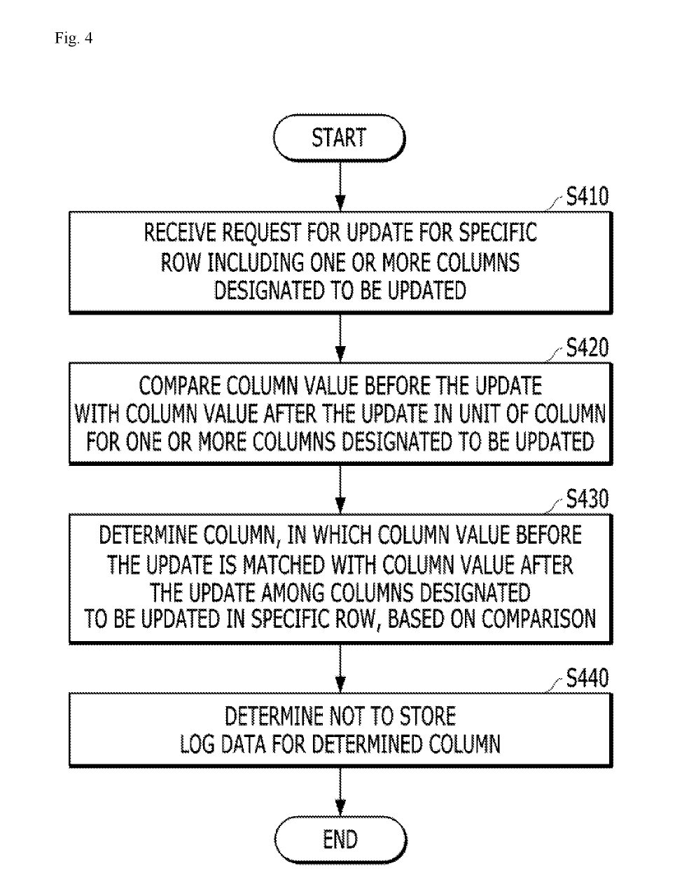

FIG. 4 is a diagram for describing a method for adaptively storing the log data related to a request for an update in the log data buffer by the database server according to the exemplary embodiment of the present disclosure.

In operation S410, the database server 1000 may receive a request for data storage and inquiry, index build and inquiry, and the like from a user. Further, the database server 1000 may receive a request for updating data included in the database from the user.

The data included in the database may have a form of a table, and the request for the update may designate one or more columns included in a specific row of the table to be updated. In this case, the request for the update may include a request for changing a column value of one or more columns among the one or more columns designated to be updated.

For example, the request for the update may include a DML request for changing a column value of one or more columns among the one or more columns designated to be updated.

In this case, the specific row may include one row or a plurality of rows, and is not limited thereto.

In response to receiving, by the database server 100, the request for the update for the specific row including the one or more columns designated to be updated, the database server 1000 may generate log data. The database server 1000 may generate log data for the specific row, and generate log data for the one or more columns designated to be updated, and is not limited thereto.

In operation S420, the database server 1000 may compare a column value before the update with a column value after the update in a unit of the column for the one or more columns designated to be updated.

For example, when the database server 1000 receives the request for updating a first column, a second column, a third column, a fourth column, and a fifth column, which are included in the specific row, the column value comparing module 1262 may compare a column value before the update with a column value after the update for each of the first column, the second column, the third column, the fourth column, and the fifth column.

In operation S430, the database server 1000 may determine one or more columns, in which the column value before the update is matched with the column value after the update, among the columns designated to be updated in the specific row based on a result of the comparison.

The database server 1000 may determine one or more columns, in which the column value before the update is not matched with the column value after the update, among the columns designated to be updated in the specific row based on a result of the comparison by the column value comparing module 1262.

In operation S440, the database server 1000 may determine not to store the log data for the one or more columns, in which the column value before the update is matched with the column value after the update, among the columns designated to be updated.

For example, the database server 1000 may determine not to store a part of the generated log data for the one or more columns, in which the column value before the update is matched with the column value after the update, among the columns designated to be updated. In this case, the database server 1000 may store the log data except for the part, which is determined not to be stored, in the log data buffer 1220.

The database server 1000 may determine to store the log data among the generated log data for the one or more columns, in which the column value before the update is not matched with the column value after the update, among the columns designated to be updated. In this case, the database server 1000 may store a part of the log data, which is determined to be stored, in the log data buffer 1220.

The database server 1000 may store the log data for the columns, in which the column values are actually changed, instead of storing the log data for all of the columns requested to be updated, in the log data buffer 1220, thereby decreasing the quantity of log data.

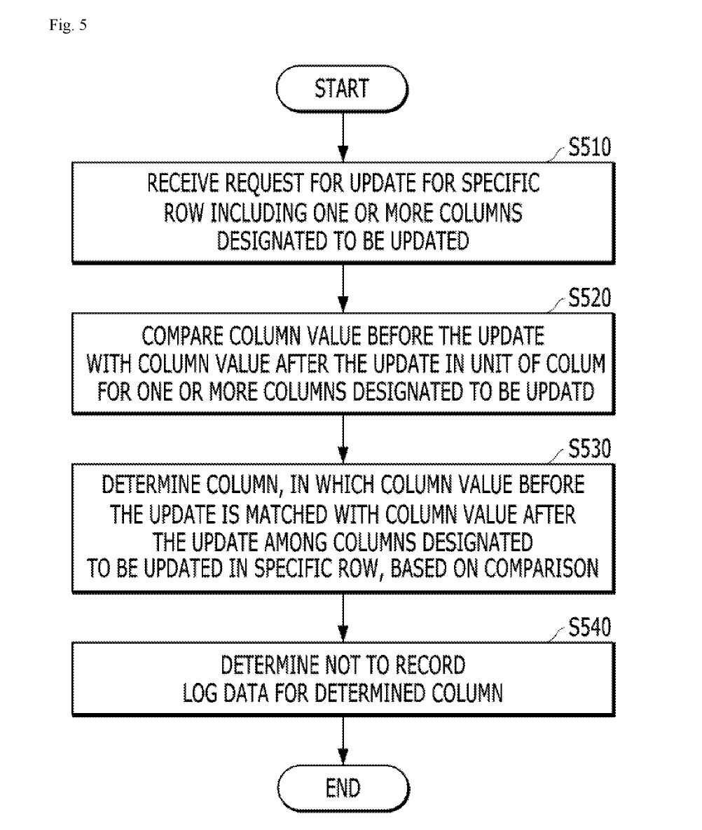

FIG. 5 is a diagram for describing a method for adaptively storing the log data related to a request for an update in the persistent storage medium by the database server according to the exemplary embodiment of the present disclosure.

In operation S510, the database server 1000 may receive a request for data storage and inquiry, index build and inquiry, and the like from a user. Further, the database server 1000 may receive a request for updating data included in the database from the user.

The data included in the database may have a form of a table, and the request for the update may designate one or more columns included in a specific row of the table to be updated. In this case, the request for the update may include a request for changing a column value of one or more columns among the one or more columns designated to be updated.

For example, the request for the update may include a DML request for changing a column value of one or more columns among the one or more columns designated to be updated.

In this case, the specific row may include one row or a plurality of rows, and is not limited thereto.

In response to receiving, by the database server 1000, the request for the update for the specific row including the one or more columns designated to be updated, the database server 1000 may generate log data. The database server 1000 may generate log data for the specific row, and generate log data for the one or more columns designated to be updated, and is not limited thereto.

The database server 1000 may store the generated log data in the log data buffer 1220.

In operation S520, the database server 1000 may compare a column value before the update with a column value after the update in a unit of the column for the one or more columns designated to be updated.

For example, when the database server 1000 receives the request for updating a first column, a second column, a third column, a fourth column, and a fifth column, which are included in the specific row, the column value comparing module 1262 may compare a column value before the update with a column value after the update for each of the first column, the second column, the third column, the fourth column, and the fifth column.

In operation S530, the database server 1000 may determine one or more columns, in which the column value before the update is matched with the column value after the update, among the columns designated to be updated in the specific row based on a result of the comparison.

The database server 1000 may determine one or more columns, in which the column value before the update is not matched with the column value after the update, among the columns designated to be updated in the specific row based on a result of the comparison by the column value comparing module 1262.

In operation S540, the database server 1000 may determine not to record the log data for the one or more columns, in which the column value before the update is matched with the column value after the update, among the columns designated to be updated.

For example, the database server 1000 may determine not to record a part of the stored log data for the one or more columns, in which the column value before the update is matched with the column value after the update, among the columns designated to be updated in the persistent storage medium 1400. In this case, the log data recording module 1267 may record the log data except for the part, which is determined not to be recorded, in the persistent storage medium 1400.

The database server 1000 may determine to record the log data among the generated log data for the one or more columns, in which the column value before the update is not matched with the column value after the update, among the columns designated to be updated, in the persistent storage medium 1400. In this case, the database server 1000 may record a part of the stored log data, which is determined to be recorded, in the persistent storage medium 1400.

In this case, the database server 1000 may store the log data in the persistent storage medium in a form of a redo log file. The redo log file means a file, in which the log data, which is various information to be stored in preparation of a fail generated within the operated database managing system 1200, is formally recorded. For example, the redo log file may include data necessary for recovering specific data into a state just before the fail is generated. For example, the redo log file may include particular contents, such as data changed according to the generation of a transaction, a transaction generation time, a processing time, a data change, and processing details.

The database server 1000 may record the log data for the columns, in which the column values are actually changed, instead of recording the log data for all of the columns requested to be updated, in the persistent storage medium 1400, thereby decreasing the quantity of recorded log data.

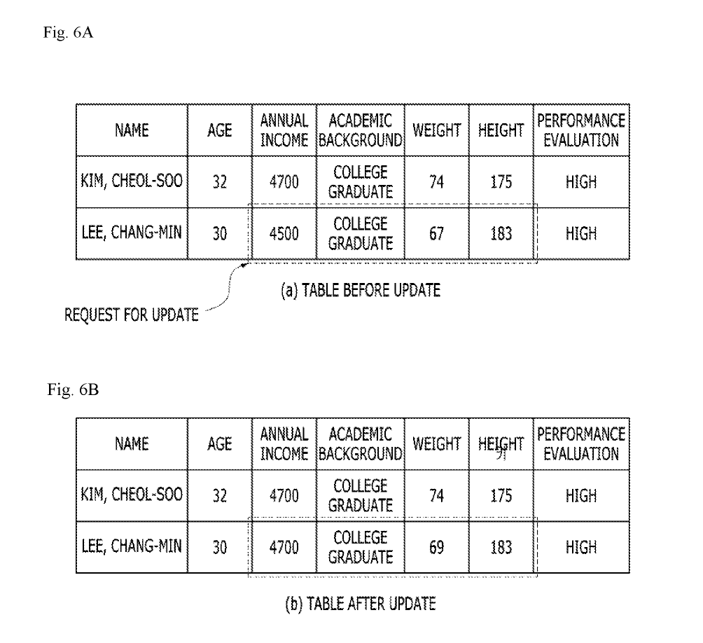

FIGS. 6A and 6B are diagrams for describing a method for adaptively generating, storing, and recording log data related to a request for an update by the database server according to the exemplary embodiment of the present disclosure.

The database server 1000 may receive a request for an update for a specific row including one or more columns designated to be updated. For example, referring to FIG. 6A, the database server 1000 may receive a request for an update for a row designated so as for annual income, academic background, weight, and height columns to be updated.

The database server 1000 may generate log data before performing the update. In this case, the database server 1000 may adaptively generate log data.

For example, referring to FIG. 6B, the database server 1000 may compare a column value before the update with a column value after the update in a unit of the column for the columns (for example, the annual income, academic background, weight, and height columns in a row “LEE, Chang-Min”) designated to be updated.

For example, the database server 1000 may generate log data for the columns (the annual income and weight columns), in which column values are changed, among the columns (for example, the annual income, academic background, weight, and height columns in the row “LEE, Chang-Min”) designated to be updated.

The database server 1000 may not generate log data for the columns (the academic background and height columns), in which column values are not changed, among the columns (for example, the annual income, academic background, weight, and height columns in the row “LEE, Chang-Min”) designated to be updated.

According to another exemplary embodiment of the present disclosure, the database server 1000 may store the log data for the columns (the annual income and weight columns), in which column values are changed, among the columns (for example, the annual income, academic background, weight, and height columns in the row “LEE, Chang-Min”) designated to be updated, in the log data buffer 1220.

The database server 1000 may not store the log data for the columns (the academic background and height columns), in which column values are not changed, among the columns (for example, the annual income, academic background, weight, and height columns in the row “LEE, Chang-Min”) designated to be updated, in the log data buffer 1220.

According to another exemplary embodiment of the present disclosure, the database server 1000 may record the log data for the columns (the annual income and weight columns), in which column values are changed, among the columns (for example, the annual income, academic background, weight, and height columns in the row “LEE, Chang-Min”) designated to be updated, in the persistent storage medium 1400.

The database server 1000 may not record the log data for the columns (the academic background and height columns), in which column values are not changed, among the columns (for example, the annual income, academic background, weight, and height columns in the row “LEE, Chang-Min”) designated to be updated, in the persistent storage medium 1400.

According to another exemplary embodiment of the present disclosure, the database server 1000 may provide the reliable method for adaptively managing log data by combining two or more of the operation of adaptively generating log data, the operation of adaptively storing the log data in the log data buffer 1220, and the operation of adaptively recording the log data in the persistent storage medium 1400 and providing the combined operations. For example, the database server 1000 may provide the operation of adaptively generating log data and the operation of adaptively recording the log data together, so that it is possible to decrease the quantity of log data through the reliable method for managing log data.

The exemplary embodiment of the present disclosure may also be implemented in a form of a recording medium including a computer executable command, such as a program module executed by a computer. A computer readable medium may be a predetermined computer-accessible available medium, and include all of the volatile and non-volatile media and the separable and inseparable media. Further, the computer readable medium may include all of a computer storage medium and a communication medium. The computer storage medium may include all of the volatile and non-volatile media and the separable and inseparable media implemented by a predetermined method or technology for storing information, such as a computer readable command, a data structure, a program module, or other data. The communication media typically includes a computer readable command, a data structure, a program module, other data of a modulated data signal, such as a carrier wave, or other transmission mechanisms, and includes a predetermined information transmission media. In this case, the computer readable recording medium may be a non-transitory recording medium.

The above description of the present disclosure is illustrative, and those skilled in the art to which the present disclosure pertains may understand that modifications to other particular forms may be easily made without changing the technical spirit or the essential feature of the present disclosure. Thus, it is to be appreciated that the exemplary embodiments described above are intended to be illustrative in every sense, and not restrictive. For example, each constituent element described in a singular form may be distributed and carried out, and similarly, constituent elements described in a distributed form may be carried out in a combination form.

The scope of the present disclosure is represented by the claims to be described below rather than the detailed description, and it is to be interpreted that the meaning and scope of the claims and all the changes or modified forms derived from the equivalents thereof come within the scope of the present disclosure.

1. A method for managing log data in a database, the method comprising:
receiving a request for an update for a specific row including one or more columns designated to be updated, the specific row being positioned within a table of a database;
comparing a column value before the update with a column value after the update in a unit of the column for the one or more columns designated to be updated;
determining a column, in which the column value before the update is matched with the column value after the update, among the columns designated to be updated in the specific row, based on the comparison; and
determining not to generate log data for the determined column, the log data being related to the request for the update.

2. The method of claim 1, wherein the request for the update includes a data manipulation language (DML) request for changing a column value of one or more columns among the one or more columns designated to be updated.

3. The method of claim 1, further comprising:
performing the update; and
notifying that the performance of the update is completed,
wherein the notifying includes notifying at least one of information about the one or more columns, in which the column value before the update is matched with the column value after the update, among the columns designated to be updated, and information about the one or more columns, in which the column value before the update is not matched with the column value after the update, among the columns designated to be updated together with the notification of the completion of the update.

4. The method of claim 1, further comprising:
determining to generate the log data for the one or more columns, in which the column value before the update is not matched with the column value after the update, among the columns designated to be updated.

5. A method for managing log data in a database, the method comprising:
receiving a request for an update for a specific row including one or more columns designated to be updated, the specific row being positioned within a table of a database;
comparing a column value before the update with a column value after the update in a unit of the column for the one or more columns designated to be updated;
determining a column, in which the column value before the update is matched with the column value after the update, among the columns designated to be updated in the specific row, based on the comparison; and
determining not to store a part of the log data related to the update corresponding to the determined column in a log data buffer, the log data being related to the request for the update.

6. A method for managing log data in a database, the method comprising:
receiving a request for an update for a specific row including one or more columns designated to be updated, the specific row being positioned within a table of a database;
comparing a column value before the update with a column value after the update in a unit of the column for the one or more columns designated to be updated;
determining a column, in which the column value before the update is matched with the column value after the update, among the columns designated to be updated in the specific row, based on the comparison; and
determining not to record a part of the log data related to the update corresponding to the determined column in a persistent storage medium, the log data being related to the request for the update.

7-10. (canceled)
